(19) United States
(12) Patent Application Publication
(10) Pub. No.: US 2014/0165768 A1
(43) Pub. Date: Jun. 19, 2014

(54) PUSH DOWN SHIFTER WITH CROSS JOINT

(71) Applicant: Eaton Corporation, Cleveland, OH (US)

(72) Inventor: Carlos Fontana, Itatiba (BR)

(73) Assignee: Eaton Corporation, Cleveland, OH (US)

(21) Appl. No.: 14/109,507

(22) Filed: Dec. 17, 2013

Related U.S. Application Data
(63) Continuation of application No. PCT/US13/75081, filed on Dec. 13, 2013.
(60) Provisional application No. 61/736,774, filed on Dec. 13, 2012.

(51) Int. Cl. F16H 59/04

(52) U.S. Cl. CPC F16H 59/04
USPC 74/473.33

(57) ABSTRACT

An exemplary shifter may include a lever, at least a portion of which may extend along an axis. The lever may be movable along the axis from and to a neutral position. The exemplary shifter may also include a spring operatively attached to the lever. The spring may be configured to bias the lever to the neutral position. The exemplary shifter further may include a lever control assembly to substantially inhibit the lever from rotating about the axis. The lever control assembly generally may remain stationary with respect to the axial movement of the lever. The lever control assembly may include a bushing around at least a portion of the lever, and through which the lever is slidable in the axial direction. The lever control assembly may also include a first pair of pins and a second pair of pins, which may form a cross joint around the bushing.

### CROSS-REFERENCE TO RELATED APPLICATIONS

This application is a continuation of International Application No. PCT/US2013/075081 filed Dec. 13, 2013, which claims priority based on U.S. Provisional Patent Application 61/736,774, filed Dec. 13, 2012, which are hereby incorporated by reference in their entirety.

### BACKGROUND

Manual compound transmissions are generally positioned within a driveline adjacent a primary drive unit with at least one rotating drive shaft. These compound transmissions generally include a shifter or gear selector that extends from the transmission for interaction with an operator. The operator, through shifter, selects an appropriate gear by pushing or pulling the shift lever to a desired shift gate. A rail selector fixed to a main shift rail is configured to translate the movement of the shift lever to shift rails and shift forks, which causes a shift collar to slide over the appropriate rotating gear to synchronize and activate a desired gear range.

One such gear range is a reverse gear range, which is less often activated. As such, shifters often incorporate measures to ensure that the reverse gear range is not accidentally or undesirably activated. One such measure may be to require the operator to first push down the shift lever before moving it to the reverse shift gate. However, because of the shape of the shift lever, the pushing down of the shift lever may result in rotational movement of the lever about an axis, which in turn may affect its flexibility for selecting and engaging a desired gear range.

### BRIEF DESCRIPTION OF THE DRAWINGS

Referring now to the drawings, exemplary illustrations are shown in detail. Although the drawings represent representative examples, the drawings are not necessarily to scale and certain features may be exaggerated to better illustrate and explain an innovative aspect of an illustrative example. Further, the exemplary illustrations described herein are not intended to be exhaustive or otherwise limiting or restricting to the precise form and configuration shown in the drawings and disclosed in the following detailed description. Exemplary illustrations are described in detail by referring to the drawings as follows:

FIG. 1 is a schematic, perspective view of an exemplary shifter for a manual transmission;

FIG. 2 is a schematic, partial perspective view of the exemplary shifter of FIG. 1 illustrating the interior of a control tower of the shifter;

FIG. 3 is a schematic, cross-sectional front view of the exemplary shifter of FIG. 2, taken along lines 3-3, illustrating the shifter in a neutral position;

FIG. 4 is a schematic, cross-sectional front view of the exemplary shifter of FIG. 2, taken along lines 3-3, illustrating the selecting of a reverse gear range of the transmission;

FIG. 5 is a schematic, cross-sectional side view of the exemplary shifter of FIG. 2, taken along lines 4-4, illustrating the shifter in a neutral position;

FIG. 6 is a schematic, cross-sectional top view of the exemplary shifter of FIG. 2, taken along lines 6-6, according to one exemplary approach; and

FIG. 7 is a schematic, cross-sectional top view of the exemplary shifter of FIG. 2, taken along lines 5-5, according to another exemplary approach.

### DETAILED DESCRIPTION

An operator of a vehicle may select a desired gear range of a transmission via a shifter. One such gear range may be a reverse gear range. Because the transmission is less often placed in the reverse gear range, it may often be desirable to have extra measures to ensure that the reverse gear range is not accidentally engaged. One such measure may be to require the operator to push down the shifter in order to engage the reverse gear range.

An exemplary shifter that incorporates such a push down measure may include a lever. At least a portion of the lever may extend along an axis. The lever may be movable along the axis from and to a neutral position. The exemplary shifter may also include a spring operatively attached to the lever. The spring may be configured to bias the lever to the neutral position. The exemplary shifter further may include lever control assembly to substantially inhibit control the movement of the lever rotationally and axially. The lever control assembly generally may remain stationary with respect to the axial movement of the lever. The lever control assembly may include a bushing around at least a portion of the lever, and through which the lever is slidable in the axial direction. The lever control assembly may also include a first pair of pins and a second pair of pins, which may form a cross joint around the bushing and the lever.

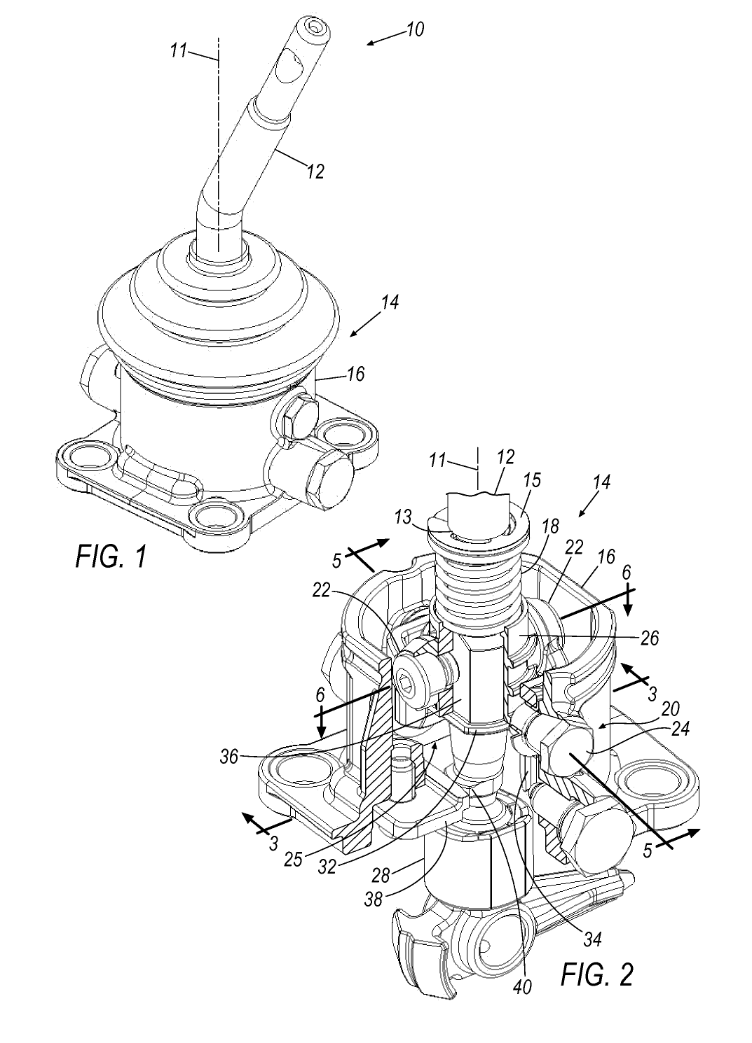

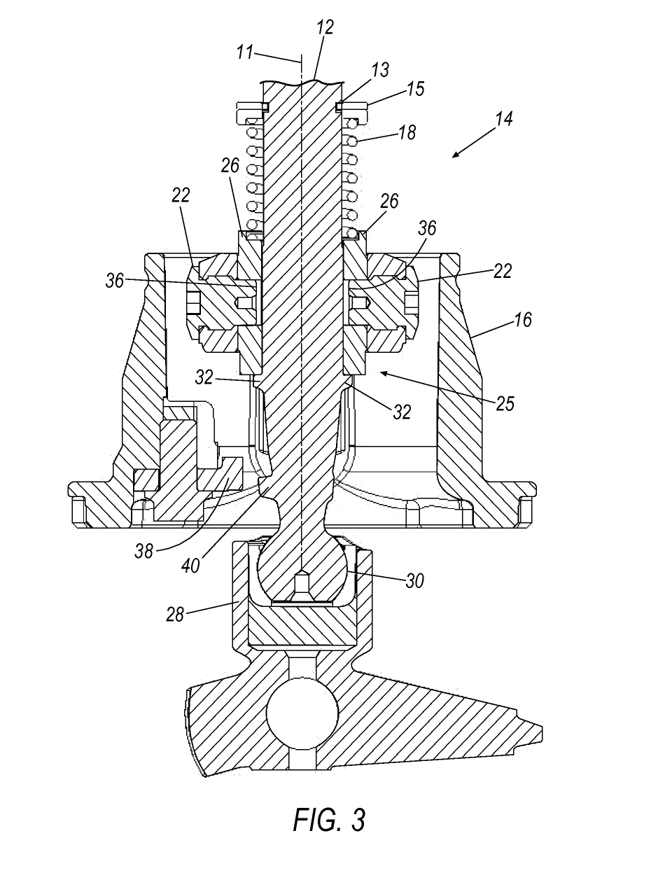

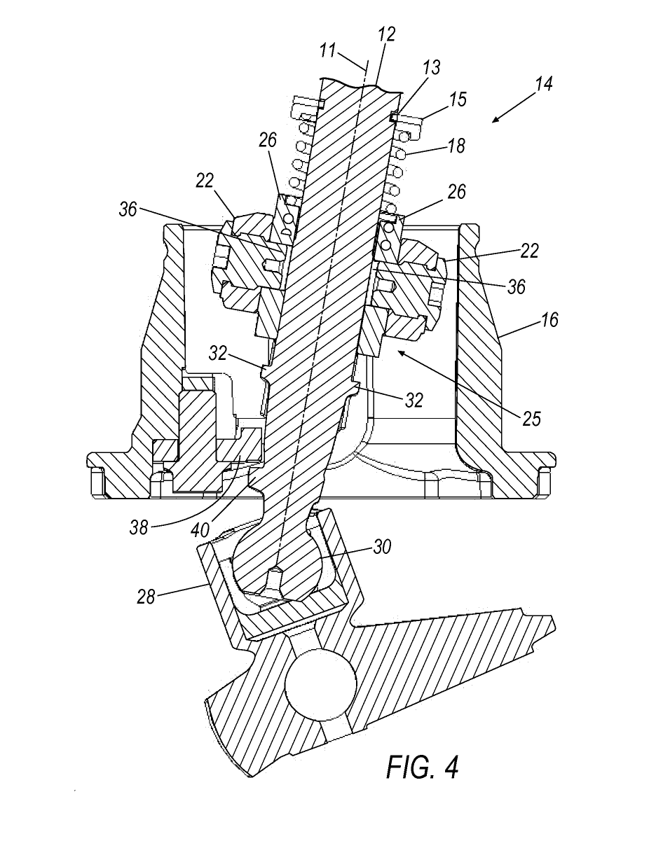

Referring to FIG. 1, a shifter 10 for selecting a gear range of a vehicle transmission is shown. The shifter 10 generally may include a lever 12 and a control tower 14, which may include a housing 16. The lever 12 may be bent such that it may be in a desirable position for an operator of the vehicle to move the lever 12. To engage the transmission in a reverse gear range, the shifter 10 may be configured such that the operator may have to push down on the lever 12, as described in more detail hereinafter. The control tower 14 may have a platform 38 and the lever 12 may have a protrusion 40 that may engage with each other when attempting to select the reverse gear range without pushing the lever 12 down. By pushing the lever 12 down, the protrusion 40 may clear the platform 38, thereby allowing the lever 12 to rotate to select the reverse gear range, as illustrated in FIGS. 3 and 4. This feature may help to ensure that the reverse gear range is not accidentally or undesirably selected. However, because of the bent configuration of the lever 12, the force exerted on the lever 12 from the position of the operator within the vehicle may cause the lever 12 to undesirably rotate about an axis 11.

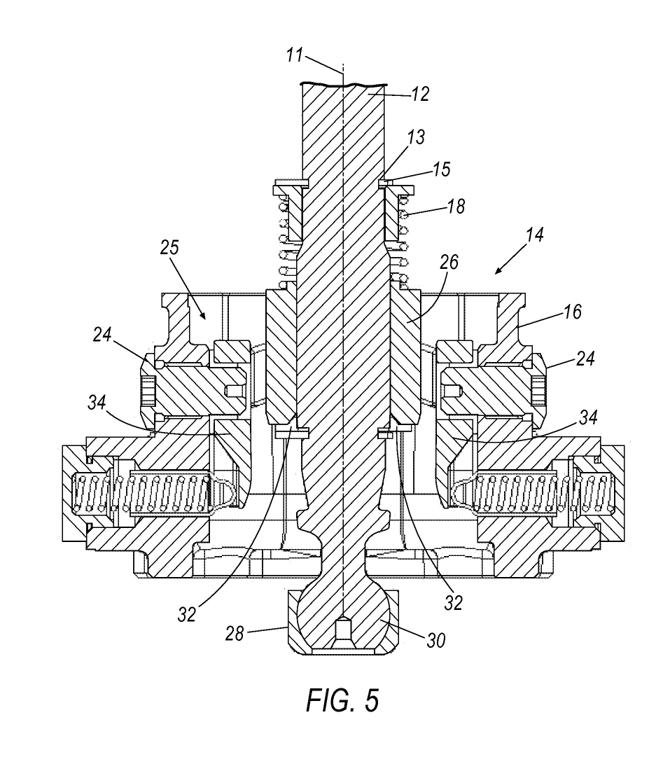

Referring now to FIGS. 2 through 5, the shifter 10 may include a spring 18 attached to the lever 12. The spring 18 may be configured to compress from a neutral generally unbiased position, as seen in FIG. 3, when the lever 12 is pushed down, thereby enabling the selection of the reverse gear range, as seen in FIG. 4, and to bias the lever 12 back to the neutral position when the transmission is disengaged from the reverse gear range. To enable this, the spring 18 may be constrained axially between a lock ring 15 and an upper surface of a first bushing 26, described below. The lever 12 may define a groove 13 configured to receive the lock ring 15. When the lever 12 is pushed down axially, the lock ring 15 may provide an upper abutting surface for the spring 18 such that it may compress. The upper surface of the first bushing 26, which may remain stationary with respect to the axial movement of the lever 12, may provide the lower abutting surface for the spring 18.

The lever 12 may have an end portion 30 configured to engage with an engagement mechanism 28. The engagement mechanism 28 generally may translate motion from the lever 12 to a main shift rail (not shown) of the transmission to select the desired gear range, such as the reverse gear range. The engagement mechanism 28 may define a cavity within which the end portion 30 may securely fit and freely move. The end portion 30 may be at least partially round or spherical such that the end portion 30 and the engagement mechanism 28 may collectively operate similarly to a ball joint. This may allow for various degrees of motion of the lever 12 for greater controllability of the main shift rail.

The shifter 10 also may include a lever control assembly 25 configured to substantially inhibit the rotation of the lever about the axis 11. The lever control assembly 25 may include a bushing 26 around at least a portion of the lever 12 within the housing 16 of the control tower 14. As explained above, the bushing 26 may be in contact with the spring 18 at an upper axial end, and generally may remain substantially stationary in the axial direction such that it provides a reactionary force on the spring 18 when it compresses, thereby allowing the axial movement of the lever 12. The lever 12 may include a ledge 32 around at least a portion of the lever 12, and extending radially outwardly from the lever 12. The bushing 26 may be in contact with the ledge 32 at a lower axial end when the lever 12 is in the neutral position, as seen in FIG. 3. When the lever 12 is moved axially downward, the ledge 32 may become disengaged from the bushing 26, as seen in FIG. 4.

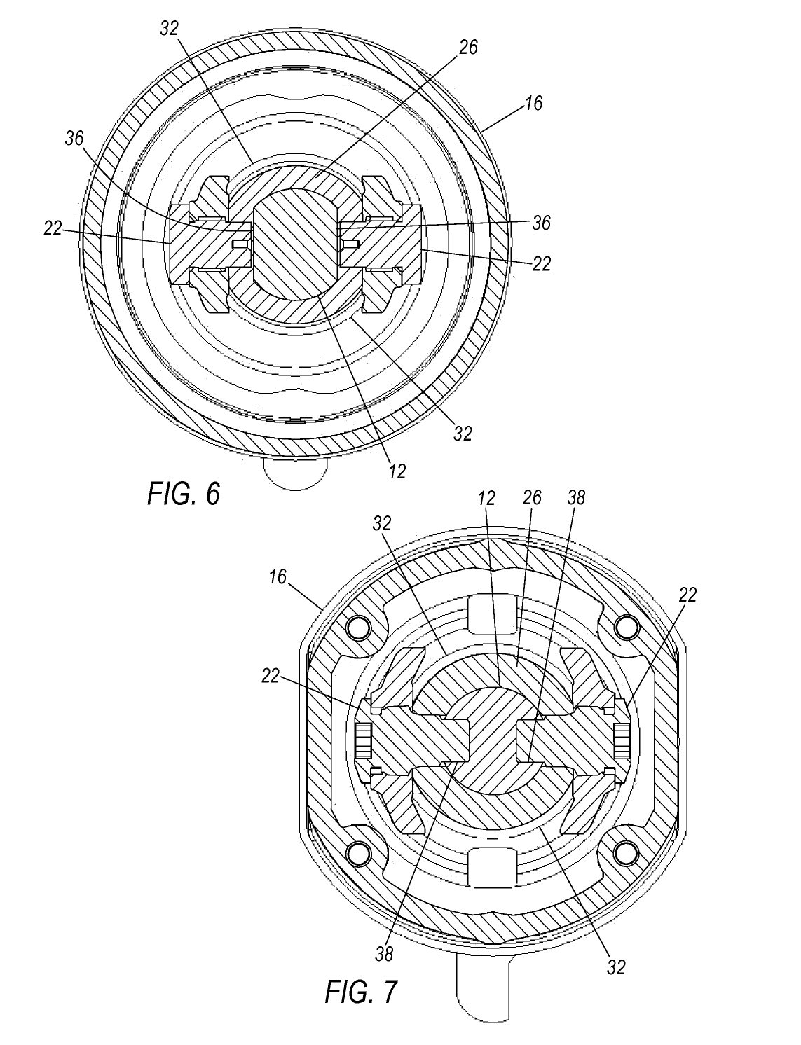

The lever control assembly 25 may also include a cross joint assembly 20 configured to engage with the bushing 26 and/or the housing 16. The cross joint assembly 20 may include a first pair of pins 22 and a second pair of pins 24. The pins 22 and 24 may be positioned radially with respect to the axis 11. The pins 22 and/or 24 may include, but are not limited to, screws, bolts, and the like. The first pair of pins 22 generally may be configured to substantially inhibit rotational movement of the lever 12 as it is being pushed down, as explained above. When the lever 12 begins to rotate, at least one mating component of the lever 12 may come into contact with a free end of each of the first pair of pins 22. For example, as illustrated in FIG. 6, the mating component(s) may be a surface 36 of the lever 12. The surface 36 may be substantially flat, which may increase the contact surface area between the pins 22 and the lever 12, thereby minimizing the chance that slippage may occur to allow the rotation of the lever 12 or any other non-axial movement. As another example illustrated in FIG. 7, the mating component may be a groove or channel 38 in which the distal end portion of the pins 22 may fit and may be slidable relative to the lever 12. The length of the channel 12 may be at least the same as the axial range of motion of the lever 12. The first pair of pins 22 may be substantially diametrically opposed to each other such that each pin 22 may equally absorb the torque generated by the rotation of the lever 12. In addition, they may form an axis around which the lever 12 may be rotatable.

The second pair of pins 24 generally may be configured to indirectly secure the bushing 26 to the housing 16 such that the bushing 26 may remain stationary relative to the axial movement of the lever 12 within the bushing 26. The lever control assembly 25 may include a connection component 34 that may interconnect the first pair of pins 22 and the second pair of pins 24, which may effectively secure the bushing 26 to the housing 16. As with the first pair of pins 22, the second pair of pins 24 may be substantially diametrically opposed to each other. This may allow for even distribution of the load of the lever control assembly 25 on each of the pins 24, and may allow for a steady connection to the housing 16. Furthermore, the second pair of pins 24 may form an axis about which the lever 12, together with the bushing 26, may rotate. The second pair of pins 24 may be positioned substantially perpendicular to the first pair of pins 22, and as such, the axes formed by the diametrically opposed first pair of pins 22 and second pair of pins 24 may be substantially perpendicular as well. Because the lever 12 may be rotatable around both axes, the perpendicular configuration may enable movement of the lever 12 at any angle, which may in turn allow for flexible selection and engagement of the gear ranges.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A shifter for selecting a gear range of a transmission, the shifter comprising:
a lever, at least a portion of which extends along an axis, the lever being movable along the axis from and to a neutral position;
a spring operatively attached to the lever, the spring being configured to bias the lever to the neutral position; and
a lever control assembly configured to control at least rotational movement and axial movement of the lever;
wherein the lever control assembly remains substantially stationary with respect to the axial movement of the lever.

2. The shifter of claim 1 wherein the lever control assembly comprises a bushing around at least a portion of the lever, a first pair of pins and a second pair of pins attached to the bushing and configured to engage with the lever when it begins to rotate about the axis, and the second pair of pins being configured to maintain the bushing in a substantially stationary position with respect to the axial movement of the lever.

3. The shifter of claim 2 wherein the first pair of pins are diametrically opposed to each other.

4. The shifter of claim 2 wherein the second pair of pins are diametrically opposed to each other, forming an axis around which the lever and the bushing are rotatable.

5. The shifter of claim 2 wherein the first pair of pins and the second pair of pins are positioned substantially perpendicular to each other to form a cross joint.

6. The shifter of claim 2 further comprising a control tower having a housing in which the lever control assembly is housed, wherein the second pair of pins is configured to engage with the housing such that the bushing is substantially stationary with respect to the axial movement of the lever.

7. The shifter of claim 2 wherein the lever includes at least one surface configured to engage with at least one of the first pair of pins when rotating about the axis such that the rotation is substantially inhibited, the at least one surface enabling the lever to slide axially within the bushing.

8. A lever control assembly for a shifter having a lever, at least a portion of which extends along an axis, the lever control assembly comprising:
a bushing through which the lever is slidable in an axial direction;
a first pair of pins configured to substantially inhibit the lever from rotating about the axis; and
a second pair of pins configured to maintain the bushing in a stationary position with respect to the axial movement of the lever.

9. The lever control assembly of claim 7 wherein the first pair of pins are diametrically opposed to each other, forming an axis around which the lever and the bushing are rotatable.

10. The lever control assembly of claim 7 wherein the second pair of pins are diametrically opposed to each other, forming an axis around which the lever and the bushing are rotatable.

11. The lever control assembly of claim 7 wherein the first pair of pins and the second pair of pins are positioned substantially perpendicular to each other to form a cross joint.

12. A shifter comprising:
a lever, at least a portion of which extends along an axis, the lever being movable along the axis from and to a neutral position;
a spring operatively attached to the lever, the spring being configured to bias the lever to the neutral position
a bushing through which the lever is slidable in an axial direction;
a first pair of pins configured to substantially inhibit the lever from rotating about the axis; and
a second pair of pins configured to maintain the bushing in a substantially stationary position with respect to the axial movement lever.

13. The shifter of claim 12 wherein the first pair of pins are diametrically opposed to each other, forming an axis around which the lever and the bushing are rotatable.

14. The shifter of claim 12 wherein the second pair of pins are diametrically opposed to each other, forming an axis around which the lever and the bushing are rotatable.

15. The shifter of claim 12 wherein the first pair of pins and the second pair of pins are positioned substantially perpendicular to each other to form a cross joint.

16. The shifter of claim 12 further comprising a control tower having a housing in which the bushing, the first pair of pins, and the second pair of pins are substantially disposed, the second pair of pins being configured to secure the bushing to the housing such that the bushing is substantially stationary with respect to the axial movement of the lever.

17. The shifter of claim 12 wherein the lever includes at least one surface configured to engage with at least one of the first pair of pins when rotating about the axis such that the rotation is substantially inhibited, the at least one surface enabling the lever to slide axially within the bushing.
